(19) United States
(12) Patent Application Publication
(10) Pub. No.: US 2016/0205726 A1
(43) Pub. Date: Jul. 14, 2016

(54) FOIL HEATER E.G. FOR A HEATING PANEL

(71) Applicant: IEE INTERNATIONAL ELECTRONICS & ENGINEERING S.A., Echternach (LU)

(72) Inventors: Thiemo SPIELMANN, Luxembourg (LU); Thomas WITTKOWSKI, Hermeskeil (DE)

(73) Assignee: IEE International Electronics & Engineering S.A., Echtemach (LU)

(21) Appl. No.: 14/913,494

(22) PCT Filed: Aug. 18, 2014
(86) PCT No.: PCT/EP2014/067580

§ 371 Date: Feb. 22, 2016

(30) Foreign Application Priority Data
Aug. 22, 2013 (LU) LU 92 270

(51) Int. Cl. H05B 3/34; H05B 3/12

(52) U.S. Cl. CPC H05B 3/34; H05B 3/12; H05B 2203/005; H05B 2203/007; H05B 2203/032

(57) ABSTRACT

A foil heater comprises a first (16) and a second (14) spiral resistive heating trace formed in a first and a second layer, respectively, that conforms to a flat or curved surface. Each of the first and second resistive heating traces has a center and at least one outer extremity. An electrically insulating layer (12) is arranged between the first and second layers. The electrically insulating layer comprises an opening that accommodates an electrical via, through which the first and second resistive heating traces are electrically contacted with each other.

### TECHNICAL FIELD

The present invention generally relates to a foil heater (i.e. a heater having the appearance of a thin, flexible foil or film), e.g., for a heating panel, especially (but not exclusively) suitable for heating the passenger compartment of a vehicle, in particular of a car.

### BACKGROUND ART

Heating panels enjoy increasing popularity in the automotive industry for heating the passenger compartment of vehicles (e.g. by radiant or contact heating) because they combine high passenger comfort with efficient use of electrical energy. Existing heating panels typically employ the same technologies as seat heaters. Specifically, they comprise resistance wires operated intermittently in accordance with a pulse-width modulation scheme. While the heating current is on, the resistance wires reach comparatively high temperatures. Moreover, due to the spacing between neighboring segments of the wires, heat is generated very locally, causing hot spots alternating with unheated areas. It is necessary, hence, to separate the wires from the passenger compartment by an equalization layer, which homogenizes the temperature distribution both in time and over the entire area of the heating panel. Inevitably, the equalization layer increases the thermal capacity of the heating panel, delays the delivery of heat to the space to be heated and impedes the heat flow toward that space. In other words, the equalization layer significantly mitigates the advantages of radiant heating.

### BRIEF SUMMARY

A foil heater is provided herein which is compatible with operation at lower temperature.

According to a first aspect of the invention, a foil heater comprises a first and a second spiral resistive heating trace formed in a first and a second layer, respectively, that conforms to a flat or curved surface. Each of the first and second resistive heating traces has a center (as used herein, the term “center” refers to the inner end of the spiral) and at least one outer extremity (as used herein the term “outer extremity” refers to the end of the outermost turn of the spiral). An electrically insulating layer is arranged between the first and second layers. The electrically insulating layer comprises an opening that accommodates an electrical via, through which the first and second resistive heating traces are electrically contacted with each other.

Thanks to their spiral shape, the heating traces can be routed densely over the entire heating surface without (or substantially without) crossings. A significantly more uniform temperature distribution can thus be achieved. It is worthwhile noting that the spiral need not be of a particularly regular shape.

The first and second resistive heating traces preferably run alongside one another (when viewed from a direction perpendicular to the first and second layers). Since the different turns of one heating trace are separated from one another by a spiral gap, the turns of the other heating trace are preferably disposed so as to run aligned with the middle line of the spiral gap. Depending on the amount of heat specified per unit area, the overlap (which is defined as the percentage of the width of a heating trace covered with a heating trace on the opposite side of the electrical insulator layer) between the first heating trace and the second heating trace may amount to between 0% (no overlap) and 50% of the width of each trace. In areas of overlap between the first and second heating traces, heat is generated on the two sides of the electrically insulating layer. Accordingly, local heat density may be significantly higher in overlap zones than in no-overlap zones. Preferably, the first and second resistive heating traces form a total overlap area of not more than 25% of the flat or curved surface.

According to a preferred embodiment of the invention, wherein the first and second resistive heating traces fill out the flat or curved surface to an extent of at least 70%. Preferably, the fill factor is even higher, e.g. about 80% or even about 90%. The higher the fill factor, the smaller is the total unheated area. In turn, the local temperature maxima can be brought much closer to the mean temperature averaged over the entire area of the foil heater.

The first and second heating traces are preferably printed or otherwise deposited layers carried by a substrate. According to a preferred embodiment of the invention, the electrically insulating layer comprises a flexible substrate with a first side having the first resistive heating trace printed thereon and a second side having the second resistive heating trace printed thereon. According to another preferred embodiment of the invention, the electrically insulating layer comprises a substrate with a first side having the first resistive heating trace applied thereon as a layer formed by electrodeposition or electroless deposition (on a first seed trace provided through any suitable printing process) and a second side having the second resistive heating trace applied thereon as a layer formed by electrodeposition or electroless deposition (on a second seed trace provided through any suitable printing process). According to yet another preferred embodiment of the invention, the first resistive heating trace is applied (deposited or printed) on a carrier film, the electrically insulating layer is printed on top of the first resistive heating trace and the second resistive heating trace printed on top of the electrically insulating layer. According to still another preferred embodiment of the invention, the first resistive heating trace is applied on a first carrier film, the second resistive heating trace is applied on a second carrier film and the electrically insulating layer is laminated between the first and second carrier films.

Preferably, the first and second resistive heating traces each have a width comprised in the range from 0.5 mm to 5 cm, more preferably in the range from 2 mm to 2 cm. Moreover, the width of the heating traces can be varied over the foil heater in order to realize variable heating power densities in different parts of the heater. If the first and second resistive heating traces form at least one crossing, the first and second resistive heating traces preferably locally widened at the crossing. Due to the widening, the resistance of the traces is reduced in the area of the crossing, leading to a reduction in heat generation. This technique can thus be used for avoiding an inhomogeneous temperature profile at crossings of the heating traces.

The electrically insulating layer preferably has thermal conductivity comprised in the range from 0.1 W/(m·K) to 1 W/(m·K).

The first and second resistive heating traces advantageously have minimum curvature radiuses that are not smaller than the widths of the first and second resistive heating traces, respectively. Preferably, the minimum curvature radiuses amount to at least four times the width of the first and second resistive heating trace.

The first and second resistive heating traces may be electrically contacted with each other at their centers. Additionally or alternatively, the first and second resistive heating traces may be electrically contacted with each other at their outer extremities.

According to a preferred embodiment of the invention, each of the first and second resistive heating traces comprises at least two spiral branches joining at their respective centers.

The electrical via may be made of highly conducting material. Preferably, however, it is made of the resistive heating material. In this case, the length, width and deposition thickness of the resistive heating material being selected such that said via contributes to heating.

If the foil heater comprises at least two electrical vias, the power source supplying the heating current may be connected to the heating traces at the electrical vias (i.e. the electrical vias serve at the same time as contact terminals).

A further aspect of the invention relates to a heating panel, e.g. a radiant heating panel, comprising a foil heater as described hereinabove and a support panel carrying the foil heater, the support panel defining the flat or curved surface, which the first and second resistive heating traces conform to. Preferably, the heating panel comprises a décor layer sandwiching the foil heater together with the support panel. The foil heater may comprise a connection tail wrapped around an edge of the support panel. The connection tail preferably carries a section of the first heating trace and a section of the second heating trace. Most preferably, the sections of the first and second heating traces are widened where the connection tail is wrapped around the edge, in such a way as to provide for increased robustness against bending stress.

Preferably, the resistive heating traces comprise essentially of a metal such as Cu, Ag, Au, Al, . . . Alternatively, the resistive heating traces may essentially comprise a composite formed of metal flakes (suitable metals are, e.g., Cu, Ag, Au, Al . . . ) and at least one polymer binder.

The connection between the first and second heating traces may be formed by a rivet or by supplementary material arranged in the opening in the insulating layer e.g. by means of printing or dispensing. The via may alternatively be formed by thermoforming or ultrasonic welding.

The foil heater may comprise at least two pairs of spirals each comprising two resistive heating traces, the pairs of spirals running alongside one another and being connected in a serial connection by
a. two vias in the center
b. by at least two vias at the outer extremities of the heating traces.

Alternatively, the foil heater may comprise at least two pairs of spirals heating different areas.

Preferably, the width and length of each of the pairs of spirals connected in parallel are adapted so that the resistances of the spirals connected in parallel are equal (“equal” meaning here <10% relative difference in resistance).

If the foil heater is part of a heating panel, the support panel preferably comprises a recess on its front side, into which the foil heater fits exactly and thereby becomes haptically imperceptible behind the décor after integration of the heating panel. According to a preferred embodiment, the foil heater is thermally insulated from the support panel using a thermal insulation layer which comprises materials such as closed foams, spacer fabrics and/or materials that are highly reflective in the infrared spectral range such as aluminum foil.

### BRIEF DESCRIPTION OF THE DRAWINGS

Further details and advantages of the present invention will be apparent from the following detailed description of several not limiting embodiments with reference to the attached drawings, wherein:

FIG. 1 is a top schematic view of a foil heater in accordance with a first preferred embodiment;

FIG. 2 is a cross section along line II-II in FIG. 1;

FIG. 3 is a top schematic view of a foil heater in accordance with a second preferred embodiment;

FIG. 4 is a top schematic view of a foil heater in accordance with a third preferred embodiment;

FIG. 5 is an equivalent circuit diagram of a heater comprising several parallel heating paths;

FIG. 6 is a schematic illustration of a crossing of two heating traces separated by an electrically insulating layer;

FIG. 7 is a schematic illustration of a curing process using light or other electromagnetic radiation;

FIG. 8 is a schematic cross section of a via according to a first implementation;

FIG. 9 is a schematic cross section of a via according to a second implementation;

FIG. 10 is a schematic cross section of a via according to a third implementation;

FIG. 11 is a schematic cross section of a via produced by heat stamping or ultrasonic welding;

FIG. 12 is a top schematic view of a via in a heater wherein the heating traces are printed one on top of the other with a printed insulating layer separating them;

FIG. 13 is a schematic cross sectional view of the via of FIG. 12;

FIG. 14 is a top schematic view of a further via in a heater wherein the heating traces are printed one on top of the other with a printed insulating layer separating them;

FIG. 15 is a schematic cross sectional view of the via of FIG. 14;

FIG. 16 is a top schematic view of a heating panel according to a preferred aspect of the invention;

FIG. 17 is a schematic cross sectional view of the heating panel of FIG. 16;

FIG. 18 is another schematic cross sectional view of the heating panel of FIG. 16 that shows the connection tail wrapped around the edge of the supporting panel;

FIG. 19 is an enlarged detail of FIG. 18;

FIG. 20 is a schematic cross sectional view of the via shown in FIG. 16;

FIG. 21 is a schematic cross sectional view of the contact of the heating trace applied directly on the carrier film of the heating panel of FIG. 16;

FIG. 22 is a schematic cross sectional view of the contact of the heating trace applied on top of the dielectric layer of the heating panel of FIG. 16;

FIG. 23 is a top schematic view of a heating panel, which is a variant of the one shown in FIG. 16.

### DESCRIPTION OF PREFERRED EMBODIMENTS

FIG. 1 schematically shows the layout of an electrical heater 10. The heater 10 comprises a flexible carrier film 12 made of electrically insulating material having a first spiral resistive heating trace 14 applied on its first side and a second spiral resistive heating trace 16 applied on its second side. The spiral resistive heating traces 14, 16 are connected with each other at their centers by means of an electrical via 18 traversing the carrier film 12. A control circuit, represented here symbolically as voltage source 20, is connected to contacts 22, 24 at the outer extremities of the heating traces 14, 16. The heating traces 14, 16 are connected in series between the contacts 22, 24. Upon application of an electrical voltage, the flow of electric current through the resistive heating traces 14, 16 on both sides of the carrier film 12 leads to the generation of heat by the resistive heating traces 14, 16.

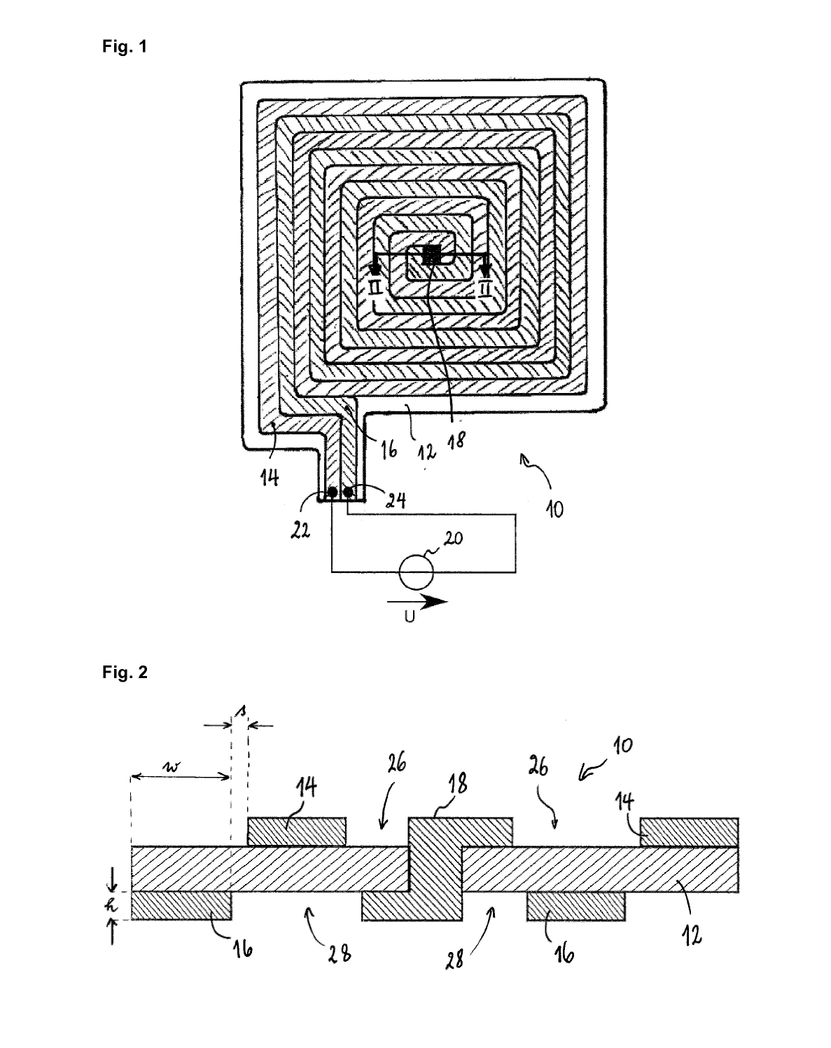

FIG. 2 shows a detail of the foil heater 10 in cross section. The individual turns of each heating trace are separated from their neighboring turns by a gap 26 or 28. The height and width of the heating traces are indicated as h and w, respectively. The horizontal spacing of two adjacent turns of the heating traces on opposite sides of the separator layer is denoted by s. The middle line of the gap 26 or 28 is vertically aligned with the middle line of the heating trace on the opposite side of the carrier film 12. The overlap of the first and second heating traces amounts to less than 25% of the area of the carrier film 12. Specifically, in the illustrated embodiment, an overlap of the first and second heating traces exists only in the center of the spirals. While each heating trace 14, 16 occupies only part (about half in the illustrated case) of the respective side of the carrier film 12, the first and second heating traces together fill the area of the carrier film 12 to an extent of no less than 70%, preferably more. With respect to FIG. 1, it is worthwhile noting that the carrier film 12 has been drawn larger than the heated area for illustration purposes only and can also be of the same size as the heated area leading to a fill factor of nearly 100%. As a result of the high fill factor, the electrical heater 10 features a most homogenous temperature distribution across the heater area. As a consequence, the requirements regarding any décor or protection layer hiding the heater are considerably relaxed in comparison to wire-based heaters.

Whereas FIG. 1 shows a heater with a rectangular contour, it will be appreciated that many more heater geometries can be filled using spiraling heating traces. Specifically, right angles or straight boundary lines are not required (but possible). It shall also be noted that the foil heater may conform itself to a curved or flat support surface thanks to its flexibility.

The heating traces of the foil heater are dimensioned such as to achieve the desired power density (=power per unit area). The resistance of the total length of the heating traces, R, is dimensioned according to Ohm's law:

R=U²/(P_{A}Aₜₒₜ) (1)

where U is the applied voltage (e.g. the on-board voltage of 13.5 V in case of a car), P_{A} is the required power density (typically between 200 and 1000 W/m²) and Aₜₒₜ is the total heater area. In the automotive domain, typical areas could be 0.05 m² for an armrest and 1.5 m² for a car ceiling. The total resistance of a conductor of bulk resistivity ρ, of length l, of width w and of height h is given by:

$$R = ρ \frac{l}{wh} . \qquad ( 2 )$$

The heating trace width w is preferably comprised between 0.5 mm and 50 mm whereas its height depends on the chosen implementation and manufacturing technique (as described in more details below) but is typically of the order of 2 μm to 10 μm.

As indicated above, high area coverage (fill factor) of the heater (denoted η) can be achieved. The fill factor is defined as the area covered by the heating traces (Aₕₑₐₜ) divided by the total heater area (Aₜₒₜ):

$$η = \frac{{A}_{heat}}{{A}_{tot}} = \frac{wl}{{A}_{tot}} , \qquad ( 3 )$$

For certain applications η>70% may be sufficient but η>90 can be reached in most cases if needed.

The required length of the traces to fulfill these requirements can be expressed as:

$$l = \sqrt{\frac{η {hU}^{2}}{ρ {P}_{A}}} \qquad ( 4 )$$

The width w then follows trivially from Eq. (3). The invented heater allows for a design of the heating traces so that the desired power density is matched.

In order to achieve homogenous temperature distribution across curved heating traces, their curvature radius is preferably chosen at least as large as the heating trace width. More preferably, the curvature radius of the heating traces is chosen at least four times larger than the heating trace width.

The heating traces on the two sides of the electrically insulating layer are applied adjacently with little or no overlap between the traces. To achieve a highly homogenous temperature distribution, the horizontal spacing s (see FIG. 2) between two heating traces on opposite sides of the separator layer preferably lies between −0.25 w and +0.25 w, where a negative value of the spacing s indicates an overlap. In FIG. 2 the electrically insulating layer is the carrier film itself and a positive horizontal spacing s is chosen. The spacing s can be constant over the entire length of the heating traces but s may be varied over the heater design, e.g. in order to suffice the minimal radius criteria mentioned above. In some locations of the heating traces, the spacing can therefore be outside of the mentioned bounds. If the spacing is varied over the heater design the average spacing is preferably chosen between −0.25 w and 0.25 w.

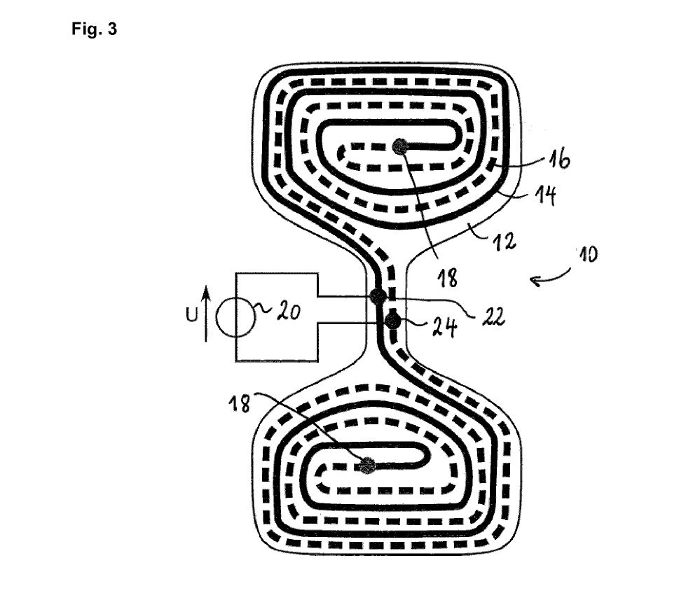

In other embodiments of the invention, several of the above-described serial circuits are operated in parallel electrical connection. It shall be noted that it is possible to prepare parallel circuits of different heating trace widths and lengths in each of the parallel paths. The total resistance of each path of the parallel circuit may be designed to be identical (which is advantageous for some particular processing features) or resistances may be different. A heater could also comprise different heating circuits that are connected each to an independent power supply. Equations (1) to (4) apply accordingly to each serial circuit. FIG. 3 illustrates a foil heater 10 comprising two paths of same resistance connected in parallel, each path being configured as the heater of FIG. 1, except for the shape. Each path comprises one via 18. In addition, in the example of FIG. 3 the resistances of all sections of the heating traces possess the same resistance, which may be advantageous in case of electro-curing as well as for achieving a homogeneous temperature distribution. A heating trace section is defined as a continuous part of a heating trace that extends between a contact 22 or 24 and a via 18.

The arrangement of the heating traces in accordance with the present invention allows for heating panel areas with highest temperature homogeneity and highest power density whereas other areas of the panel can be exempted from being heated. Such exempted areas are typically those regions of the panel where either heating is not desired or where the three-dimensional curvature of the panel impedes draping of the heater.

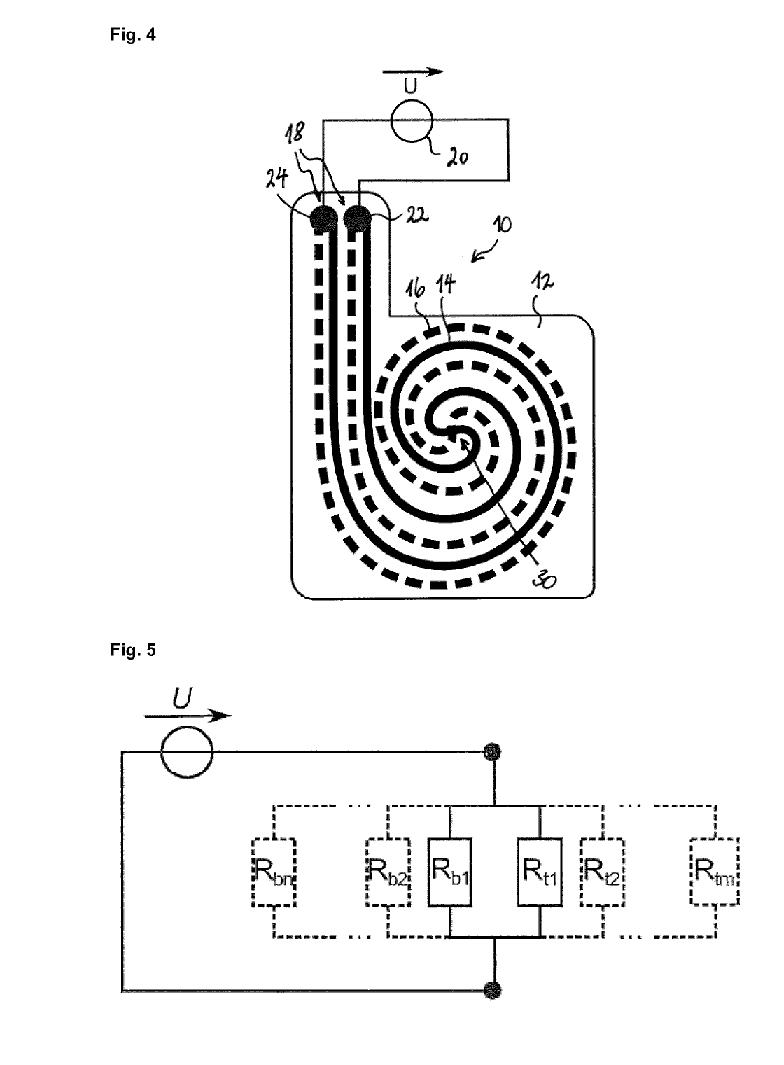

In yet another implementation, the contacts are implemented as vias. In the embodiment illustrated in FIG. 4, each contact 22, 24 is formed as a via, so that the circuit comprises two electrically parallel paths (one on each side of the separator layer). Further heating traces could be connected between the contacts 22, 24. It is worthwhile noting that the parameters (length, width, specific resistance, etc.) of each heating trace could be chosen individually, in accordance with the specific requirements in the area occupied by that trace. FIG. 5 shows the corresponding equivalent circuit, R_{bi}, i=1, . . . , n designating the resistances of the traces on the bottom side of the electrically insulating layer and Rₜⱼ, j=1, . . . , m designating the resistances of the traces on the top side of the electrically insulating layer.

Different realizations of the electrically insulating layer (separator layer) can be used. According to a first preferred embodiment thereof, the carrier film itself is used as the separator layer and the heating traces are applied on each side of the carrier film (cf. embodiment of FIGS. 1 and 2). This realization has the advantage that the total heater thickness is minimized, whereby the final mounting of the heater is simplified. Another advantage is that production techniques, such as, e.g., printing or galvanic coating, can be applied on opposite sides of the carrier film in one pass and at the same time.

According to another embodiment, both conductor layers are applied both on the same side of a carrier film (substrate) and the separator layer is provided as an electrically insulating coating (e.g. a dielectric print), for which the same application technique may be employed as for the heating traces. In this case, the separator layer typically possesses a thickness of 0.5 μm to 50 μm, preferably between 5 μm and 30 μm. For some production techniques, this embodiment has the advantage that the substrate need not be coated from both sides.

According to yet another realization, the foil heater comprises two carrier films, each carrying one layer of the heating traces, bonded together by an electrically insulating, adhesive tape. For instance, a double-sided adhesive tape with a thin carrier foil having a total thickness of 50 μm or less may be used for this purpose. This realization simplifies the design of the vias if openings are placed into the adhesive tape at the via positions.

As is shown in FIGS. 1 and 3, the foil heater may be achieved without a crossing between heating traces on opposite sides of the separator layer. In certain situations, however, it is useful to allow one or several crossings of traces on opposite sides of the substrate (see e.g. the central crossing 30 in FIG. 4). In order to avoid more intense heating in the regions where the conductors on both sides of the substrate cross (which would result in a higher local temperature) the resistance of the traces is lowered in these regions by increasing the trace width or trace height. FIG. 6 shows the situation where the widths of the opposite traces 14, 16 are appropriately increased at a crossing 30. The widths of the heating traces at a crossing is preferably determined taking into account the desired temperature distribution as well as the materials used.

The same technology that is used to prepare a via can be used to bring the contact for the bottom conductor to the top surface of the separator layer. In this way, contacting the heater may be achieved from one side only, which simplifies industrial contacting. Contacting techniques include but are not limited to soldering, crimping, clinching, and riveting.

In all presented embodiments and implementations, different materials can be used as substrates. In preferred realizations, polymer foils made of PET, PEN, PU, PI, and others are used as carrier films. Such polymer films would typically possess thicknesses between 5 μm and 175 μm, preferably between 12 μm and 125 μm. In the case that the film carrier is also used as separator layer, the thickness of the polymer foil is chosen as small as possible.

For best heating efficiency, the thermal conductivity of the carrier film should be as high as possible, typically between 0.02 W/(m·K) and 1 W/(m·K), preferably between 0.1 W/(m·K) and 0.4 W/(m·K). The specific heat capacity of the carrier film is preferably between 500 J/(kg·K) and 2000 J/(kg·K). In general, and more critically when used as isolation layers, the carrier films should present a high volume resistivity (>10⁸ Ω·cm).

Several techniques may be used for forming the heating traces. The most relevant techniques are presented in the following.

The heating traces may be applied by electroplating on top of an initial seed layer as explained, for instance, in documents EP 2 124 515 B1 and EP 1 562 412 A2. The initial seed layer is applied on a carrier film by any suitable printing technology. The seed layers do not require conductance as high as the final heating traces. To reach the required conductance, the carrier film is passed into an electroplating bath, while a voltage is applied on the seed layer using contact electrodes. This voltage triggers the deposition of the dissolved metal onto the seed layer (electroplating). In the realization of this product, copper is preferred although other metals could also be used. Typical deposition heights of 3 to 30 μm can be produced in this process.

The heating traces could also be formed in a similar manner by electroless plating. In this case, the seed layer need not be contacted during the plating process. However, generally the deposition speed is much slower for electroless plating compared to electroplating.

As a first alternative to plating, the heating traces of the panel heater can be produced by printed circuit board (PCB) technology, such as lithography and subsequent etching steps of an initial copper foil on top of a polymer foil. These techniques are well known in manufacturing of flexible PCB and allow for the production of several conductor layers separated by either the substrate or a dielectric material and connected to each other by vias. Typically, PI foils of substrate thicknesses of 25 μm to 50 μm are used for the production of flexible PCB's but other substrates and thicknesses can also be used. Standard copper film thicknesses of 18 μm and 35 μm can be used. These large thicknesses will result in rather high conductance of the heating traces and, therefore, rather narrow heating traces are possible. Depending on the mechanical stress the heater needs to withstand in the product application, either electrodeposited high-ductility (EDHD) or rolled annealed (RA) copper films can be employed for producing the heaters.

As an alternative to PCB technology and plating, printing techniques may be applied to produce the heating traces. Suitable printing techniques include but are not limited to (rotary) screen printing, gravure printing, flexographic printing and inkjet printing. These printing techniques are well known from the development of printed electronics and do not need a detailed description here.

Suitable conducting inks are all those that fulfill the requirements of Eqs. (1)-(4) and that retain their initial conductance after 15 years of operation in the product (±30% resistance variation being deemed acceptable). Since high conductivity materials are required, inks based on silver and on copper are preferred. Copper has the advantage of cheapness, whereas silver may be considered preferable because of its environmental long-term stability. In general, however, all metal-based inks could be employed.

Depending on the used printing technique and inks, print thicknesses between 100 nm and 50 μm, preferably between 500 nm and 15 μm can be produced.

Depending on the ink used, conductivities between 6% and 90% of the bulk Cu/Ag conductivity can be reached. Typically, the highest possible conductivity is used for highest design flexibility. The given conductivity range is equivalent to a conductor resistivity between 30×10⁻⁸ Ωm and 1.85×10⁻⁸ Ωm. The thermal conductivity of the printed heating traces (after curing) is chosen between 100 W/(m·K) and 500 W/(m·K) and the heat capacity between 100 J/(kg·K) and 400 J/(kg·K).

Prints need to be exposed to elevated temperatures in order to reach their required, high conductivity. The curing/sintering of conductive prints may be achieved in convection ovens. Moreover, since the heating traces have the same cross-sections for design reasons, Joule heating by applying short electrical pulses is a powerful way to cure and sinter the prints (“electro-curing” or “electro-sintering”), provided that the softening temperature of the substrate is not exceeded. For sufficiently short electrical pulses only heating up the print but not the substrate, the required voltage is given by Eq. (5):

$$U \text{/} l = \sqrt{\frac{Δ T}{{t}_{p}} {ρ}_{Ohm} {ρ}_{dens} {c}_{p}} \qquad ( 5 )$$

where l is the conductor length, tₚ is the pulse duration, ρ_{Ohm}, the resistivity, ρ_{dens} the mass density of the print and cₚ the specific heat capacity of the print.

The typical electrical power required is ˜10¹¹ W/m³, corresponding to voltages of 500-3000 V per meter of heating trace. The duration of the sintering process is preferably between 1 μs-10 s, preferably between 100 μs-100 ms in order to avoid heating up the film carrier.

The contacting of the heating traces to the power source with the aim of electro-curing/sintering is preferably done at the heater contacts and/or at the vias. A prerequisite for electro-curing/sintering is an initial conductivity of the heating traces. An initial conductivity can be obtained by an upstream curing step in a standard convection oven at low to intermediate temperatures (<1 min, 60-150° C.).

If Joule heating is carried out with a direct contact current, the non-cured/sintered print needs to be contacted with a low resistance contact. If an alternating current is used, the contact to the print can be of capacitive nature.

For electro-curing/sintering, it is of special advantage if certain parts of the circuit that are connected to the power source used for electro-curing/sintering possess equal resistance. In this case all circuit parts are cured/sintered simultaneously which reduces the process complexity and costs. The vias are particularly valuable for this purpose, since they allow one to fractionate the total circuit in conductor sections of equal resistance. This method is preferable for the implementations illustrated in FIGS. 1, 3, and 4. In total only two connecting points are needed for electro-curing/sintering. Electro-curing/sintering is well suited for production of the vias in case the production process of the vias is a printing process.

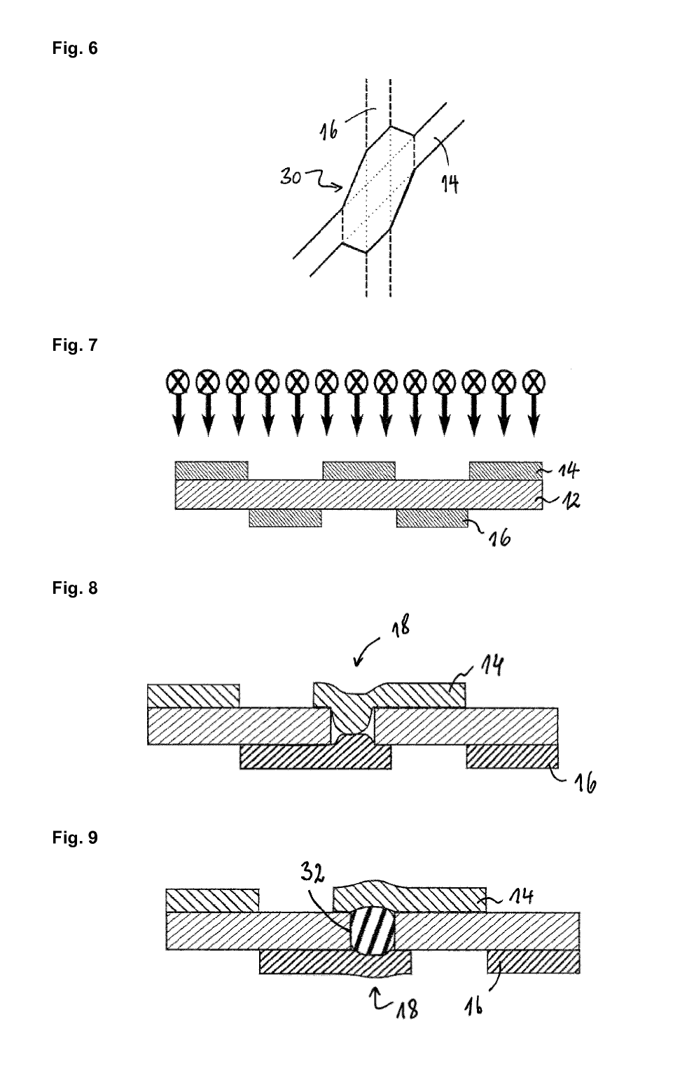

Another possibility would be to cure/sinter the prints by applying electromagnetic radiation. The electromagnetic radiation source is chosen such that its radiation spectrum matches the absorption spectrum of the print but not (or only to negligible amounts) the absorption spectrum of the substrate. Typically, irradiation in the visible to near infrared range is well suited for selectively heating the print. Depending on the thickness and properties of the print, the print may be irradiated by continuous irradiances between 0.1 W/cm² and 100 W/cm² during e.g. 0.1 s to 10 s in order to reach sufficiently high temperatures for curing/sintering the ink. Alternatively, the print could be irradiated by one or several consecutive light pulses of typically 0.1 to 20 milliseconds in duration. This allows selectively heating the print, whereas the substrate remains close to room temperature. In these cases, the required peak irradiances are typically higher and of the order of 1 kW/cm² to 10 kW/cm². The energies per pulse are typically in the range between 0.5 J/cm² and 10 J/cm². Heating traces on both sides of the substrate may be cured cured/sintered by illumination with light of appropriate wavelength from one side of the heater. Heating traces on both sides of the substrate will be heated because of 1.) the transparency of the substrate wrt. the radiation used, 2.) the absorbance of the conductive print wrt. the radiation used, and 3.) the geometrical arrangement of heating traces on both sides of the substrate which allows for a free optical path to the heating traces at the rear side of the substrate (see FIG. 7). EM-wave heating of prints is well suited for production of the vias in case the production process of the vias is a printing process.

If the heating traces are produced by electroplating or electroless plating technology, the connections (vias) between the traces through the substrate are preferably produced in the same plating process.

The vias can also be formed by passing metallic compounds such as rivets, semi-tubular rivets or hollow rivets through the substrate and thereby connecting the prints. In order to ensure the electric contact between the print and the rivet, the heating traces can be printed thicker at the location of the rivet or a second print can be applied on top of the rivet.

If the heating traces are produced by functional printing with the carrier film used as separator layer, a connection between the two heating traces on opposite sides of the film carrier is preferably achieved by providing one or several fine openings through the substrate, which are then filled with the conductive ink in a subsequent printing process. To ensure a good electrical contact, the opening diameter is preferably chosen greater than the carrier film thickness and the print used for the via is of a thickness at least approximately equal to that of the film carrier. These openings may be produced by mechanical die punching, by laser cutting, by drilling or by any other automated process. The diameter of the openings is preferable between 10 μm and 5 mm, more preferably between 20 μm and 500 μm. To further improve the mechanical stability and to reduce the resistance of the via, an array of openings (e.g. of 5 by 5 openings) may be prepared. In order to avoid excessive heating of the via, it may be dimensioned in a way to have a similar or lower resistance than the heating trace by ensuring that the total cross section of the opening or array of openings is equal or larger than the cross section of the printed heating trace. It shall be noted that the openings may have arbitrary shape and need not be circular.

For thin carrier films (carrier film thickness comparable to or smaller than that of the print), the vias are preferably filled with ink during the printing process of the heating traces 14, 16. FIG. 8 shows a schematic cross-section through a via 18 produced in that way. For thicker films, it is useful to fill the openings prior to the heating trace printing by deposition of an intermediary print 32 in the region of the opening(s) as is illustrated in FIG. 9. This intermediary print 32 may comprise the same or a different conductive material than that of the heating traces 14, 16. Moreover, the intermediary print 32 can be deposited by printing, dispensing or any other automated deposition technique.

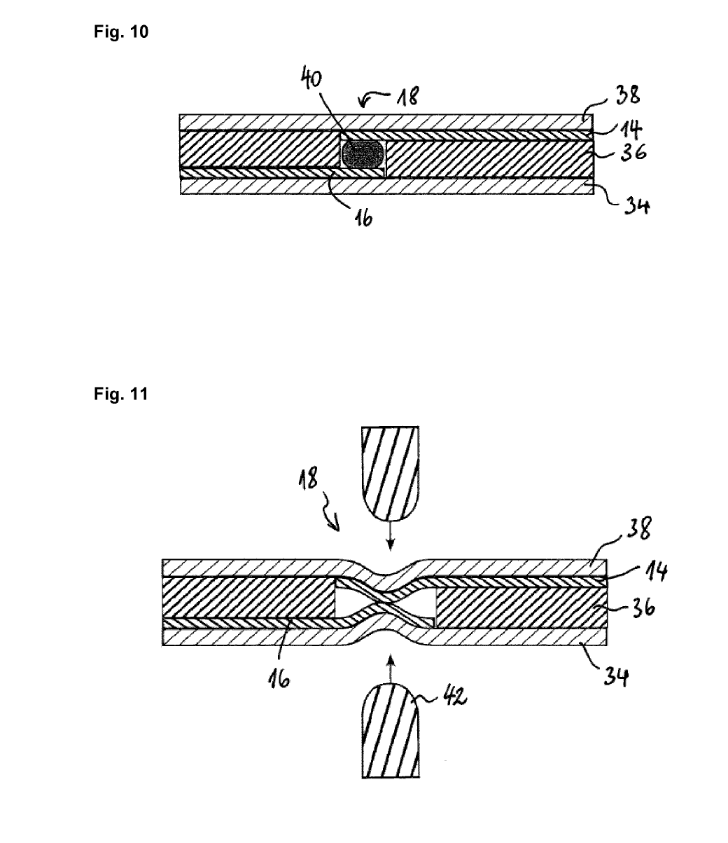

When adhesive tape 36 is used as the separator layer between the heating traces 14, 16 printed each on a separate carrier film 34, 38 (cf. FIG. 10), a via is formed by providing openings (e.g. of diameter 0.1 mm to 20 mm) in the adhesive tape 36 prior to the lamination process. These openings may e.g. be produced by mechanical die punching, laser cutting, drilling or any other automated process. Again, the openings may have arbitrary shape. In the via fabrication process, electrically conductive material 40 is deposited (from liquid phase by means of a printing or dispensing process) in the region of the opening in order to establish good electrical contact between opposing heating traces. The via material 40 may comprise different conductive material than that of the heating traces 14, 16. When the via has been formed, the top substrate carrying one of the heating traces is laminated to the adhesive tape.

As illustrated in FIG. 11, the contact between the opposite heating traces 14, 16 separated by an adhesive tape 36 arranged between them may also be established by heat stamping, i.e. pressure is exerted on the carrier films in the region of an opening in the adhesive tape such that the first and second heating traces 14, 16 are put into contact and heat is applied in order to weld the traces to each other. Typically, a contact pressure amounting to between 1 and 10 bar would be applied during 0.5 s to 10 s and the temperature would be raised to about 50° C. to 150° C.

The contact between opposite heating traces in the region of the via 18 may, in particular, be established by ultrasonic welding. According to this technique, a so-called sonotrode 42 is brought in intimate contact with the outer surface in the region of the via. The mechanical displacement amplitudes in the kHz frequency range (typical 20 kHz) are chosen maximal in the depth where the two conducting layers from the opposite sides of the separator layer need to be welded in order to establish a durable low-resistance contact.

Due to the minimal radius requirement, the central area of the foil heater cannot, in some cases, be filled with heating traces. In these circumstances, it is advantageous to provide a via, which heats up this central area. Preferably, the conductivity of the via is chosen such as to yield the same power density in the region of the via as in the heating traces.

In case the heating traces are printed on the same side of a substrate and are separated by a dielectric layer, the connection between the two layers is achieved through openings in the dielectric layer at the location(s) of the via(s) and the connection between the two layers may be made with the same print as the top heating trace or using a different material deposited by printing, dispensing or any other automated deposition technique. The printed dielectric layer may be thicker than the heating traces. To avoid hot spots at the locations of the vias, the heating traces may be printed thicker and/or several conductor prints may be applied at the locations of the vias. It may be beneficial to print the dielectric layer thinner around the vias in order to diminish the height step to be bridged between the heating traces. The openings accommodating the vias may have arbitrary shapes; in particular, they need not be circular or symmetrical.

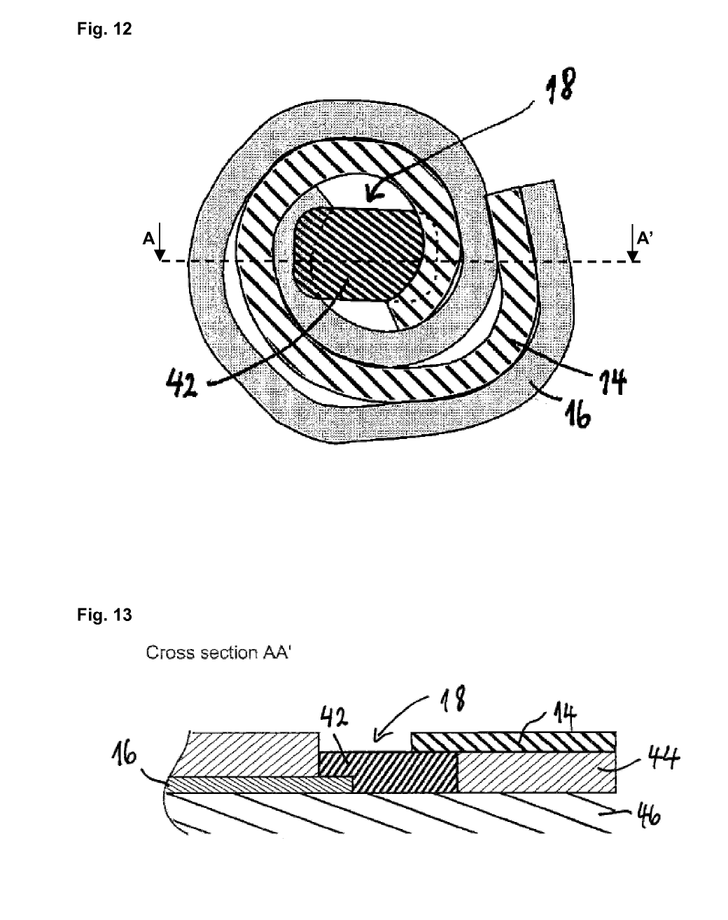

FIGS. 12 to 15 show two possible implementations of a heating via 18 embodiments, wherein the heating traces 14, 16 are printed on the same side of a substrate 46 and are separated by a dielectric layer 44. In the embodiment illustrated by FIGS. 12 and 13, the heating traces 14, 16 overlap only partially with the material 42 of the via 18. Considering for example a via having width 2w, length 3w and thickness 2h (where w and h are defined as in FIG. 2), the resistivity of the via layer would be chosen as 4ρ, ρ being the resistivity of the heating traces 14, 16. Moreover, the viscosity of the ink used for printing the via 18 is preferably adapted so as to guarantee an approximately constant total deposition thickness in the opening in the dielectric layer 44. It shall be noted that the layers shown in FIGS. 12 and 13 can be applied in 4 printing steps: step 1: printing the first heating trace 16 on the substrate 46; step 2: printing the dielectric layer 44, step 3: dispensing/printing the via material 42; step 4: printing the second heating trace 14.

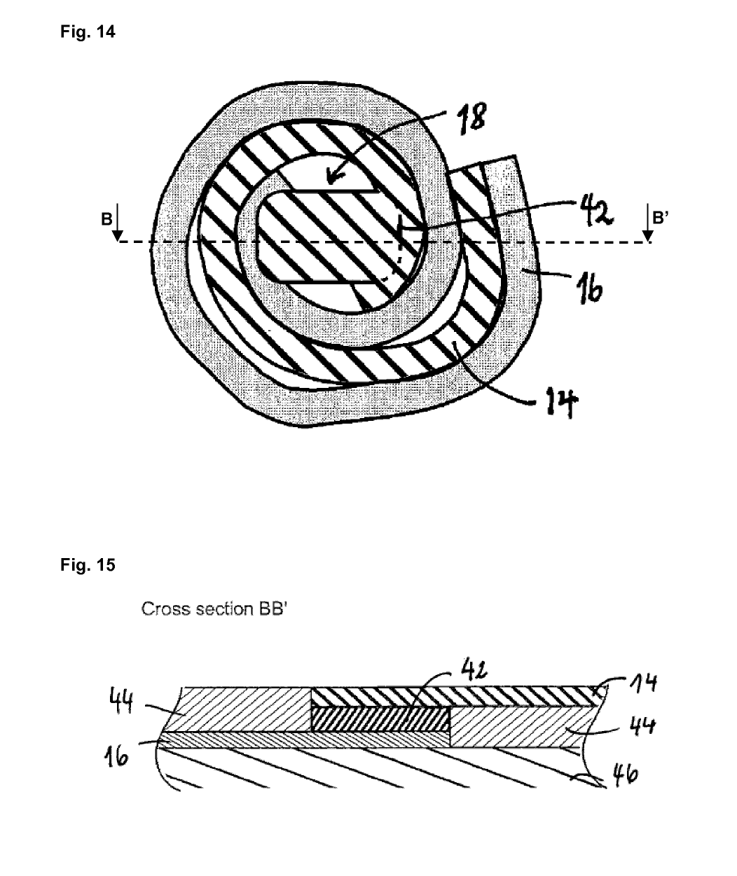

In the embodiment illustrated by FIGS. 14 and 15, the heating traces 14, 16 completely overlap with the via material 42. In this case the resistivity of the via 18 can be higher than in the previous embodiment; for instance, a carbon black ink suffices for connecting the two heating traces 14, 16. The manufacturing steps are otherwise the same as for the previous embodiment.

In order to increase the long-term stability of the heater when exposed to humidity or chemicals, the heating traces 14, 16 are preferably covered with a protective coating. Such a varnish or another dielectric layer may e.g. be applied in a printing or in a wet coating process.

An industrial process of heater integration may comprise panel lamination, back injection molding or any other technique, which reliably fixes the foil heater to a support. A typical structure of such a heating panel comprises a décor layer, the foil heater and the support, which is e.g. a pre-formed panel or a mold part.

The heater may be thermally separated (insulated) from its mounting panel to reduce the time needed to raise the temperature at the free décor surface to the desired temperature. The insulation of the heater in the direction of its supporting panel or mold can be achieved by the use of insulating materials such as closed foams, spacer fabrics and/or materials that are highly reflective in the infrared spectral range (such as aluminum foil). Additionally or alternatively, the support panel or the support mold could itself be made of a thermally insulating material.

Rear-side thermal insulation contributes to reducing the required electrical energy needed for heating up as well as for operation at the desired constant temperature, which is typically below 60° C.

The structure of the foil heater disclosed herein may be very thin and thus requires only a minimum of extra integration space. In a heater, where the carrier film plays the role of the separator layer, the total thickness of the heater can be as small as 50 μm to 200 μm and its mass per unit area may be distinctly below 100 g/m². Film-based heaters thus enable clearly thinner designs than wire-based heaters. The high heater area coverage (fill factor) further reduces the need for additional foam or similar layers to yield a homogenous heating distribution at the décor and thereby decreases the required integration space of the heater even further in comparison to conventional wire-based heaters.

The use of thin film-based heaters furthermore drastically simplifies the integration of the heater to the support panel or mold. In particular for elastomeric PU films, their superior drapability allows the heater to follow the curvature of three-dimensional topographies of the panel or the mold.

The heater does not necessarily extend over the complete mounting panel or mold. In particular, if the drapability of the heater is limited it is favorable to insert the heater (whose dimensions are determined by the size of the carrier film) only in those regions of the panel having comparatively low three-dimensional curvature. High-curvature regions would in this case remain unheated.

The mounting panel can present a small recess slightly deeper than the film-based heater (for example 0.5 mm) for accommodating the heater without its edges becoming perceptible through any décor layer.

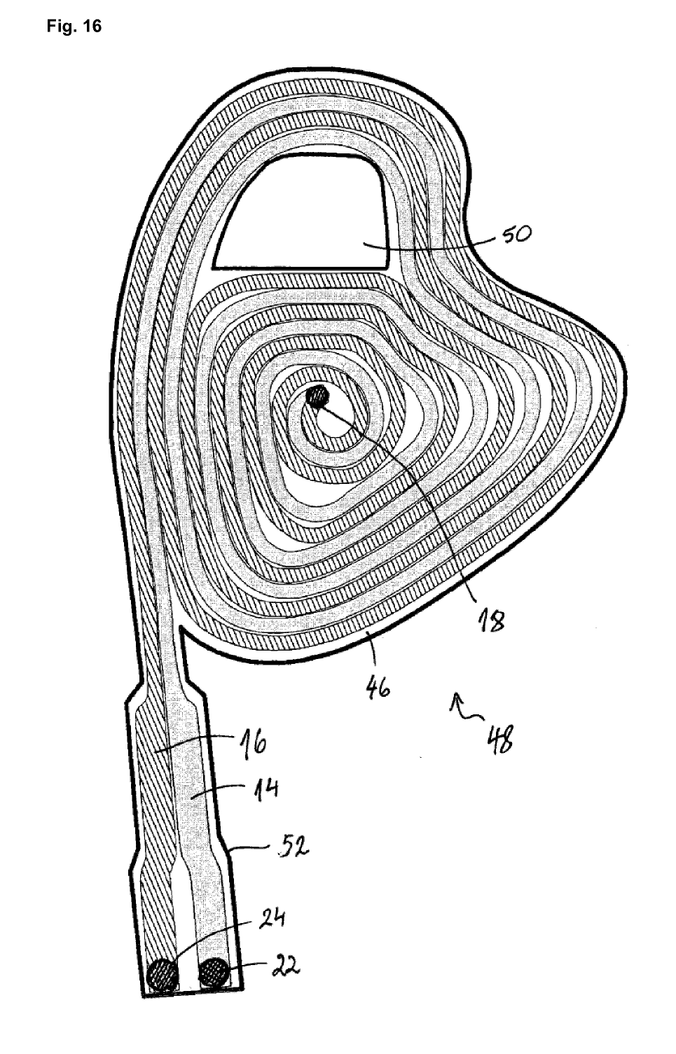

In the following, a heating panel 48 will be described, wherein the separator layer is a printed dielectric 44 and the via 18 is realized by screen printing (flat bed or rotary) in five subsequent printing and drying steps. A top view of the heating panel 48 is sketched in FIG. 16. The heating panel 48 comprises an opening 50. The heating panel 48 is suited as part of a door panel where the door handle is positioned in the opening 50 of the panel. The heater comprises two contacts 22, 24 arranged on a contacting area (“connection tail” 52), where the heating traces 14, 16 may be connected to the voltage supply and control electronics.

In the illustrated example, the width of the heating traces 14, 16 is 20 mm. The resistivity of the print has been selected ρ=4·10⁻⁸ ∩·m. The sheet resistance of the heating traces is 4.1·10⁻³ Ω, thus yielding a resistance per length unit of R/I=0.2 Ω/m. The total length of the heating traces amounts to approximately 15 m. The heating traces follow essentially parallel spiral courses on the opposite sides of the separator layer and are connected to each other by a via 18 in the center of the spirals. Both heating traces are of the same width and approximately equal length. The total power of the heater, operated with an on-board voltage of 13.5 V, is approximately 60 W. The heating traces are disposed as much as possible with the same spacing between them in order to provide a homogenous temperature distribution. The heater exhibits an area coverage greater than 90% corresponding to a power density of P_{A}=200 W/m², calculated with the heater area excluding the tail (folding and contacting regions). The so achieved surface temperature on the décor surface is approx. 40° C. under stationary conditions. The connection tail 52 is designed to possess an overhang of approx. 5 cm in length on the backside of the supporting panel 54. It should be noted that in FIG. 16 the tail is not represented to scale for illustration purposes.

The fabrication of the foil heater of FIG. 16 will now be explained in more detail. The carrier film 46 of the heater is a temperature stabilized PET film having a thickness 0.125 mm, the surface of which is chemically pre-treated in order to improve adhesion of the prints. Temperature stabilization of the film warrants a dimensional shrinkage smaller than 0.1% when exposed to a temperature of 150° C. for 15 min, which is important for the registration of the various printed layers.

In a first printing step, the first heating trace 16 is printed using a polymer thick film ink containing silver nanoparticles, solvents as well as some additives that improve certain ink properties beneficial to the printing process. In addition, the contact area 22 for the second heating trace 14 is applied in the same printing step (see FIG. 22). This contact area 22 has a length extension of 10 mm at least. After the first printing step, the applied print is dried in a convection oven at 150° C. for approx. 45 s. The typical dry film thickness of the printed layer is about 0.01 mm.

In a second printing step, a dielectric polymer print is applied as the separation layer 44. This layer covers the complete heater area including the connection tail except for the region of the via 18 and the regions of the electrical contacts 22, 24. At the position of the via 18, an opening in the dielectric print is left open. The opening is given a diameter identical to the width of the heating traces14, 16. At the contacts 22, 24, the dielectric print is applied in such a way as to leave the conducting print applied in the first printing step partially uncovered. The dielectric print is cross-linked (cured) by UV-irradiation. A UV dose of approx. 1 J/cm² (measured in the UV-A spectral range) may e.g. be suitable. The thickness of the cured dielectric print 44 is approximately 0.03 mm.

In a third printing step, the via 18 and the contact areas 22, 24 are filled with a conductive print (e.g. a silver nanoparticle ink). Overprinting of the dielectric layer 44 is avoided. The thickness of this print layer is chosen approximately twice as high as in the first printing step. Drying is carried out essentially as in the first printing step but the drying time is moderately increased to 90 s.

The second heating trace 14 is carried out in a fourth printing step. Ink, printing and drying parameters are identical to those of the first printing step. The print applied in the fourth printing step contacts the via 18 and the respective contact area 22.

In a final printing step, a dielectric cover 56 is printed over the complete heater area leaving out the contact areas of the first and second heating traces. For ease of contacting, the length of the conductive structure not covered with the dielectric should at least be 10 mm. Inks and drying parameters are chosen identical with those used in the second printing step.

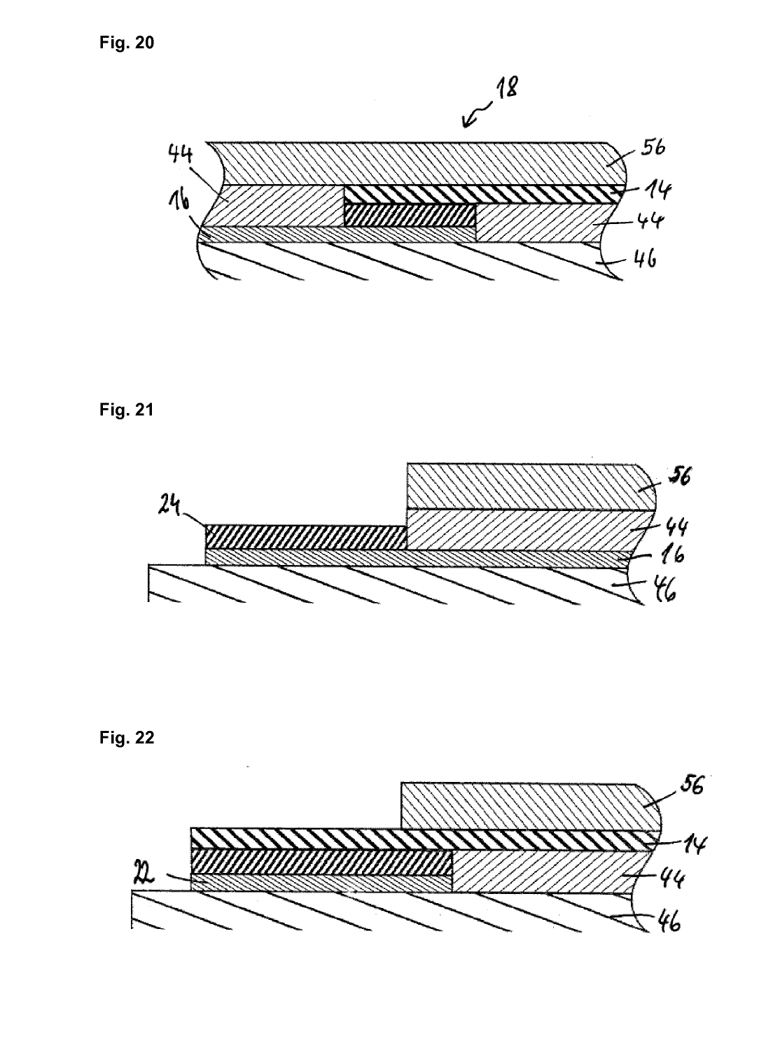

Cross-sections of details of the heater of FIG. 18 are shown in FIGS. 20 to 22. FIG. 20 is a cross section of the via; FIG. 21 is a longitudinal cross section of the contact 24 of the first heating trace 16 and FIG. 22 is a longitudinal cross section of the contact 22 of the second heating trace 14.

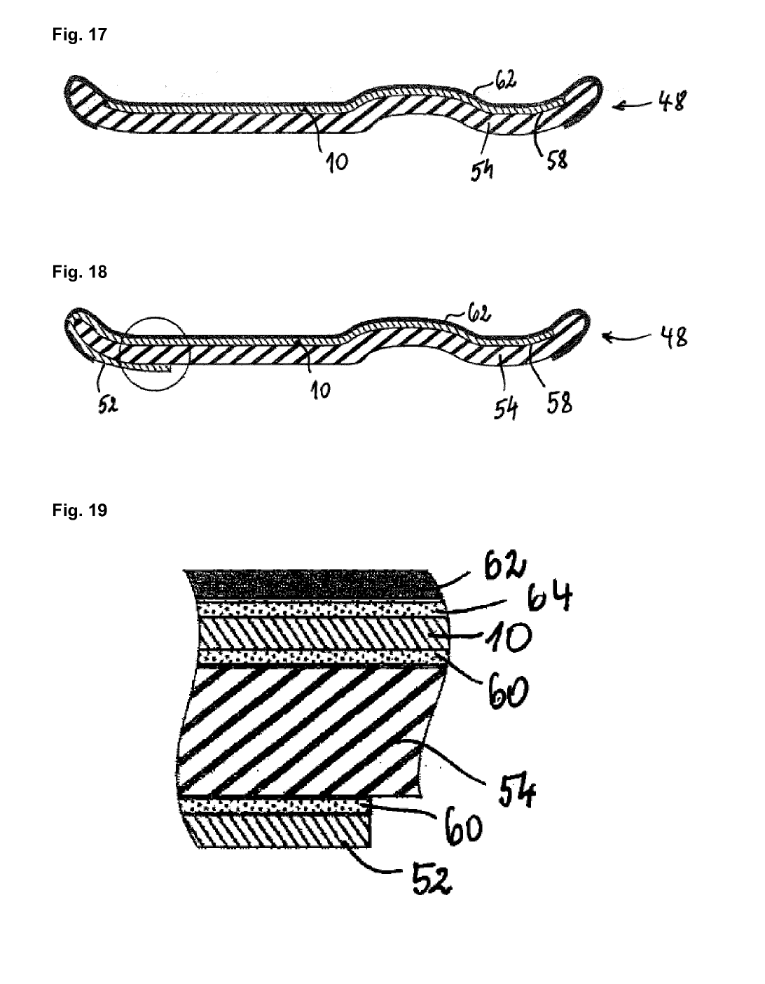

As best illustrated in FIGS. 17 and 18, the heating panel has a three-dimensional shape. The local radiuses of curvature are preferably greater than 5 cm. The supporting panel 54, which carries the flexible heater 10 and which thus defines the three-dimensional shape thereof, possesses a recess 58 with a depth of 0.2 mm, chosen so that the décor surface is essentially smooth after lamination and assembly of the panel heater and that the foil heater cannot be detected through the décor by haptic perception. The shape of the recess 58 matches the shape of the flexible heater 10. As illustrated in FIG. 18, the connection tail 52 of the heater is turned over onto the backside of the supporting panel 54. To this end, the supporting panel 54 features a so-called “tail recess”, which extends from the main recess 58 on the front face of the supporting panel 54, around the edge of the panel, to the backside thereof.

The supporting panel 54 is preferably made of fiber-reinforced polymer composite material, fiber-reinforced rigid foam or another light-weight and thermally insulating panel material.

The foil heater 10 may be attached to the supporting panel 54 in a hot lamination process. In such process, a temperature-reactive two-component adhesive 60 is sprayed on those sides of the heater and the panel, respectively, that are to be glued together. The supporting panel is heated up and, after air drying of the adhesive 60, the heater 10 is positioned in the recess 58 of the suitably supported and heated panel 54 and is pressed against the panel 54 with a pressure of approximately 1 bar at a temperature of approximately 125° C. for approximately 30 s. During this procedure the connection tail 52 is kept bent around the panel edge and is glued into the tail recess of the panel.

It is worthwhile noting that heating traces 14, 16 advantageously have a greater width and/or thickness where they extend into the connection tail than in the spiral region. Such increased width/thickness permits the heating traces to better withstand the bending stress, which occurs during the assembly and to reduce the voltage drop in the connection tail. In the embodiment illustrated in FIG. 16, the width of the heating traces in the connection tail is increased by a factor of about 2.

As shown in FIGS. 17 to 19, the heating panel 48 comprises a décor compound 62 applied on top of the film-type heater 10. The décor compound 62 is composed of a laminate of a thin, opaque PU film (0.025 mm), a thin reticulate foam (0.5 mm thickness, PET) and a warp-knit décor fabric (200 g/m², PET), which forms the outermost layer of the heating panel 48. Preferentially a décor of low thermal resistivity and highest emissivity is chosen. Here the composite décor material shows a thermal resistivity of approximately 0.023 m²·K/W and an emissivity of 0.91.

The décor compound 62 is applied over the complete front side of the panel in a further hot lamination process so as to fully cover the printed heater. The lamination process parameters are similar to those of the process of laminating the printed heater onto the panel. The adhesive layer that attaches the décor compound to the heater 10 is designated by reference number 64 in FIG. 19.

Electrical contacting with a power supply may e.g. be achieved with multicore leads insulated with PP or silicone. The cables are preferably pre-confected comprising a crimp connector on one side and a standard power connector at the supply side. The crimp connectors are crimped in the contact areas on the connection tail. So-called hot-melt, a thermo-reactive two-component polymer is subsequently applied over the complete contacting area in such a way that a.) all metallic parts are covered, and b.) the connection tail and the cables are fixed to the backside of the supporting panel. The hot-melt then also acts as a strain relief. Finally, a felt may be arranged over the complete tail and hot-melt regions on the backside of the panel by means of a double-sided adhesive. The total thickness of the contacting including the felt cover is typically lower than 3 mm.

The so produced heating panel has substantially the same thickness as the panel without heater. Due to the recess in the panel and the low thickness of the film-type foil heater (e.g. below 0.2 mm) the printed heater is neither tangible nor visible from the compartment side.

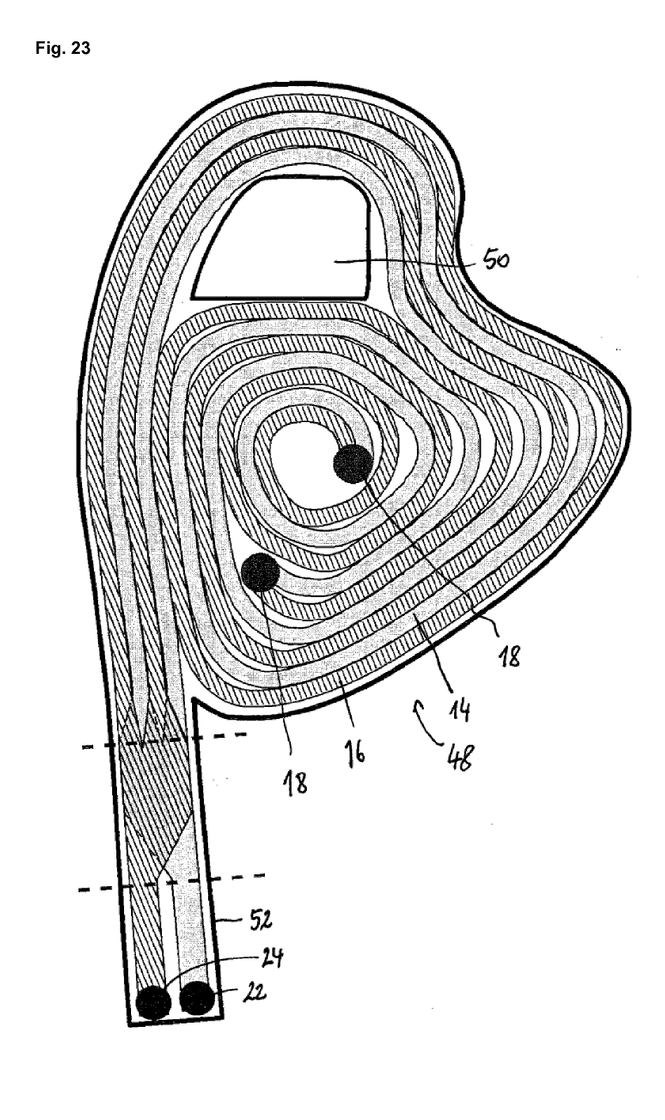

FIG. 23 shows an alternative layout of the heating traces 14, 16 and the vias 18. The foil heater of FIG. 23 has the same outline as that of FIG. 16 but comprises two pairs of heating traces showing all a width of 20 mm. Each pair of heating traces comprises one spiral heating trace printed below the dielectric layer and another spiral heating trace printed on top of the dielectric layer, the heating traces being connected to each other through a via 18. These two pairs of heating traces, having approximately the same total length (approximately 7 m) and resistance, are connected in parallel in the connection tail.

This heater of FIG. 23 can be manufactured with the same processing steps and materials (including conductivity of the silver nanoparticle ink) as the heater discussed with respect to FIG. 16. However, by adapting the thickness of the heating traces to 5 μm, the thickness of the dielectric layers to 10 μm, the thickness of the vias and contacting areas to 10 μm, the sheet resistance becomes 8.10⁻³ Ω. The total power of the heater, operated with a voltage of 13.5 V, is then approximately 130 W. The heater exhibits an area coverage of approximately 88% corresponding to a power density of P_{A}=420 W/m², calculated with the heater area excluding the connection tail 52.

While specific embodiments have been described in detail, those skilled in the art will appreciate that various modifications and alternatives to those details could be developed in light of the overall teachings of the disclosure. Accordingly, the particular arrangements disclosed are meant to be illustrative only and not limiting as to the scope of the invention, which is to be given the full breadth of the appended claims and any and all equivalents thereof.

1. A foil heater, comprising
a first spiral resistive heating trace formed in a first layer conforming to a flat or curved surface, said first resistive heating trace having a center and at least one outer extremity;
a second spiral resistive heating trace formed in a second layer conforming to said flat or curved surface, said second resistive heating trace having a center and at least one outer extremity; and
an electrically insulating flexible substrate with a first side and a second side opposite to said first side, said electrically insulating flexible substrate being arranged between said first and second layers such that said first resistive heating trace is arranged on said first side of said electrically insulating flexible substrate and said second resistive heating trace is arranged on said second side of said electrically insulating flexible substrate, the arrangement being such that, when viewed from a direction perpendicular to the first and second layers, said first and second resistive heating traces run alongside one another, and wherein said electrically insulating flexible substrate comprises an opening accommodating an electrical via through which said first and second resistive heating traces are electrically contacted with each other.

2. The foil heater as claimed in claim 1, wherein said first and second spiral resistive heating traces each have different turns being separated from one another by a spiral gap, and wherein the first and second spiral resistive heating traces are arranged on their respective side of the electrically insulating flexible substrate in such a way that, when viewed from a direction perpendicular to the first and second layers, the turns of the second heating trace are arranged so as to run aligned with a middle line of the spiral gap between the turns of the first heating trace said first and second resistive heating traces run alongside one another.

3. The foil heater as claimed in claim 12, wherein said first and second resistive heating traces fill out said flat or curved surface to an extent of at least 70%.

4. The foil heater as claimed in claim 1, wherein said first and second resistive heating traces form an overlap area of not more than 25% of said flat or curved surface.

5. The foil heater as claimed in claim 1, wherein said first and second resistive heating traces are applied to the respective sides of the flexible substrate by means of a printing process.

6. The foil heater as claimed in claim 1, wherein first and second resistive heating traces are applied to the respective sides of the flexible substrate by electrodeposition or electroless deposition.

7. (canceled)

8. The foil heater as claimed in claim 1, wherein said first resistive heating trace is applied on a first carrier film, said second resistive heating trace is applied on a second carrier film and said electrically insulating flexible substrate is laminated between said first and second carrier films.

9. The foil heater as claimed in claim 1, wherein said first and second resistive heating traces have a width comprised in the range from 0.5 mm to 5 cm, preferably in the range from 2 mm to 2 cm.

10. The foil heater as claimed in claim 1, wherein said electrically insulating layer has thermal conductivity comprised in the range from 0.1 W/(m·K) to 1 W/(m·K).

11. The foil heater as claimed in claim 1, wherein said first and second resistive heating traces have minimum curvature radiuses not less than the widths of said first and second resistive heating traces, respectively.

12. The foil heater as claimed in claim 1, wherein said first and second resistive heating traces are electrically contacted with each other at their centers.

13. The foil heater as claimed in claim 1, wherein said first and second resistive heating traces are electrically contacted with each other at their outer extremities.

14. The foil heater as claimed in claim 1, wherein each of said first and second resistive heating traces comprises at least two spiral branches joining at their respective centers.

15. The foil heater as claimed in claim 1, wherein said electrical via is made of resistive heating material, the length, width and deposition thickness of said resistive heating material being selected such that said via contributes to heating.

16. The foil heater as claimed in claim 1, wherein said first and second resistive heating traces form at least one crossing and wherein said first and second resistive heating traces are locally widened at said crossing.

17. The foil heater as claimed in claim 1, comprising at least two electrical vias and a power source connected to said heating traces at said electrical vias.

18. A heating panel, comprising
a foil heater as claimed in claim 1, and
a support panel carrying said foil heater, said support panel defining said flat or curved surface, which said first and second resistive heating traces conform to.

19. The heating panel as claimed in claim 17, comprising a décor layer sandwiching said foil heater together with said support panel.

20. The heating panel as claimed in claim 17, wherein said foil heater comprises a connection tail wrapped around an edge of said support panel, wherein said connection tail carries a section of said first heating trace and a section of said second heating trace.

21. The heating panel as claimed in claim 19, wherein said sections of said first and second heating traces are widened where said connection tail is wrapped around said edge.
